(19) United States
(12) Patent Application Publication
(10) Pub. No.: US 2021/0308924 A1
(43) Pub. Date: Oct. 7, 2021

(54) METHOD FOR DIAGNOSING A STATE OF AT LEAST ONE COMPONENT OF A MOLDING MACHINE

(71) Applicant: ENGEL AUSTRIA GmbH, Schwertberg (AT)

(72) Inventors: Andreas NEUHOLD, Linz (AT); Harald FRAUENEDER, Garsten (AT)

(21) Appl. No.: 17/220,401

(22) Filed: Apr. 1, 2021

(30) Foreign Application Priority Data
Apr. 3, 2020 (AT) A 50284/2020

(51) Int. Cl. B29C 45/84; B29C 45/58; B29C 45/66

(52) U.S. Cl. CPC B29C 45/84; B29C 45/661; B29C 45/585

(57) ABSTRACT

A method of diagnosing a state of at least one component of a molding machine is performed such that a state of the at least one component is determined on the basis of a vibration measured at the molding machine. A drive unit of the molding machine accelerates and/or decelerates at least one movable element provided at the molding machine in such a way that the vibration is stimulated in a predetermined frequency range.

### BACKGROUND OF THE INVENTION

The present invention concerns a method for diagnosing a state of at least one component of a molding machine, a molding machine configured to carry out such a method, and a computer program product.

Molding machines can be understood as injection molding machines (especially plastic injection molding machines), injection presses, presses and the like. In the following, the prior art will be outlined on the basis of an injection molding machine. The same applies, of course, to molding machines in general.

It is known from the prior art to determine a state of at least one component of the molding machine on the basis of a vibration measured at the molding machine.

It is, for instance, known from US 2008/0111264 A1 to carry out frequency measurements at an injection molding machine for monitoring the injection molding machine or for detecting occurring damages. It is taught to place sensors with which a vibration can be measured at such places of the injection molding machine where vibration changes indicating damages are most clearly detectable. Such places can be identified, for example, with a finite element analysis software or through testing.

In this case, the vibration is stimulated either by the running operation of the molding machine or by an external stimulation. Such an external stimulation is also known in the prior art as the “impulse hammer method”, in which the injection molding machine is stimulated to a vibration by a short blow (for example by a hammer).

Another method is described in AT 13307 U1, wherein vibrations are recorded by vibration sensors on the drive device of a plasticizing unit during operation. The recorded vibrations are then compared with reference vibrations, wherein conclusions can be drawn regarding a damage to the drive device.

EP 2 102 728 B1 also deals with the diagnosis of the state of injection molding machines, wherein structure-borne sound measurements are carried out specifically on the injection molding machine for this purpose. It is described that during operation a measurement is carried out by a specially arranged structure-borne sound measuring device, wherein subsequently a frequency distribution can be determined by means of a spectral analysis, wherein damage can be inferred from a comparison of an envelope curve of the frequency distribution with reference curves.

The disadvantage of the methods known from the prior art is that additional and expensive measuring sensors must be specifically arranged on the injection molding machine, wherein—as already described above—the placement of the sensors is not trivially feasible and, in case of incorrect placement of the sensors, measured values are generated which are not significant for a diagnosis of the injection molding machine.

A further disadvantage of the methods known in the prior art is that the injection molding machines are globally stimulated to a vibration by the running operation or, for example, a hammer blow, whereby a vibration significant for the entire injection molding machine is detected, but cannot be clearly inferred to individual components, whereby in case of a vibration change the presence of a defect is generally detectable, but this cannot be clearly assigned to a component.

### SUMMARY OF THE INVENTION

The object of the present invention is to provide a method for diagnosing a state of at least one component of a molding machine that is improved and/or simpler and/or more significant than the prior art, a molding machine configured to carry out such a method, as well as to provide a corresponding computer program product.

According to the invention, a drive unit of the molding machine accelerates and/or decelerates at least one movable element provided on the molding machine in such a way that a vibration is stimulated in a predetermined frequency range. This vibration can then be measured and a state of at least one component of the molding machine can be determined based on this vibration measured at the molding machine.

The targeted, that is, selective, vibration stimulation in a predetermined frequency range according to the invention makes it possible to generate a vibration which is adapted to at least one component of the molding machine. Even in case of a vibration of the entire molding machine, a specific component—more precisely, the state of a specific component—can be analyzed in a targeted manner via the vibration evaluation.

Since essentially each component of a molding machine has a different natural frequency range, the targeted stimulation in a certain frequency range can be used to target at least one component during vibration analysis even when the entire molding machine is vibrating.

This makes it possible, for example, to use existing measuring devices on the molding machine for vibration measurement. In this way, for example, an existing sensor on a molding machine can be used to measure a vibration, and the existing drive system can be used for stimulation.

The invention makes it possible in a simple way to diagnose already existing systems, preferably without extension by an additional measuring system, by the method according to the invention.

Through the present invention, measuring devices—more precisely, their sensors—no longer have to be arranged at very specific positions of the molding machine, since the vibration measurement can already be specifically adapted to at least one component due to the predetermined frequency range, and it is not additionally necessary to pick up this vibration at the component to be diagnosed, because the vibration of the entire molding machine already provides information about the state of this at least one component.

Furthermore, stimulation in a predetermined frequency range makes it possible to obtain more precise information about a state of at least one component of the molding machine. Since the vibration for diagnosis is limited to a certain frequency range (which is adapted to the component of interest), the remaining components of the molding machine have little influence on the diagnosis, whereby a state of the at least one component can be determined more precisely compared to stimulation during operation, in which the stimulated vibration with its frequency range is not adapted to a specific component, since the vibration adapted to the at least one component interacts comparatively less with other components of the molding machine.

Molding machines can be understood as, for example, injection molding machines (especially plastic injection molding machines), injection presses, presses or the like.

It may be provided to select the predetermined frequency range such that at least one natural frequency of the at least one component to be diagnosed lies in the predetermined frequency range. In particular, when stimulating a frequency range in which the at least one natural frequency of the at least one component to be diagnosed lies within the frequency range, results in the special advantage of a particularly meaningful vibration stimulation, which allows very meaningful conclusions to be drawn about the state of the at least one component. Preferably, the predetermined frequency range is closely arranged around the at least one natural frequency, so that an unwanted stimulation of natural frequencies of other components than the component of interest is avoided.

The natural frequency(ies) of a component can nowadays for instance be determined in a simple way by finite element programs. Alternatively, the natural frequencies can however also be determined by means of testing.

In the course of the invention, it is advisable for diagnosing to select, for example, a natural frequency (since components generally have considerably more than one natural frequency) which distinguishes itself from possible “background noises”, and is preferably different from natural frequencies of other components.

Background noises are understood to mean vibrations of the molding machine which already extend over the molding machine without additional stimulation and, if appropriate, are stimulated by the environment, for example by other molding machines located nearby.

Preferably, a lower, absolute limit is set for a frequency range which is to be applied in the course of the invention, since the vibration with a lower frequency would be lost in a noise carpet of various other vibrations which are always present, and thus would no longer be clearly identifiable.

Preferably, the predetermined frequency range is defined by a plus/minus of 5% (in the unit Hz—Hertz) of the natural frequency around the natural frequency of the at least one component to be diagnosed.

Preferably, a vibration of the molding machine and/or of the at least one movable element and/or of the at least one component to be diagnosed is stimulated as vibration.

At least one ambient condition may be taken into account when defining the predetermined frequency range.

Such an ambient condition can, for instance, be a temperature, a lubrication, or also a contamination of a guide on the molding machine. These exemplary environmental factors have a significant influence on the vibration of the molding machine, since they play a major role in the damping behavior of the molding machine, wherein a change in this damping behavior of course also significantly alters the vibration or the vibration curve.

By taking this into account already when defining the frequency range, a change in the ambient condition can be taken into account in advance, and a falsification of the measuring result due to this change in the environment can be minimized or ruled out in advance.

Preferably, a movable plate of the molding machine is used as the movable element, which is accelerated and/or decelerated via a closing unit—which preferably has a toggle mechanism.

However, embodiments are also imaginable in which, for instance, an ejector set of a molding machine and/or the plasticizing unit of a molding machine are accelerated and/or decelerated by a drive unit in order to stimulate a vibration.

In the course of the present document, when referring to a plate, it is not necessarily to be assumed that it is flat and level. It can also have recesses and elevations. Embodiments with ribs for stabilization or to produce a certain deformation behavior are also quite thinkable.

Basically speaking, this means that any moving part on the molding machine can be used to stimulate a vibration on the molding machine. However, from a physical point of view, the bigger the mass of the moving element, the easier it is to stimulate a vibration on the molding machine.

A measuring device of the molding machine may be used to measure the vibration. As already mentioned, the present invention makes it possible to use already existing measuring devices of the molding machine for vibration measurement.

Stimulation in a certain defined frequency range makes it possible to diagnose at least one specific component by a vibration of the entire molding machine with high precision, which makes it necessary to provide additional measuring devices on the component to be diagnosed.

As measuring devices of the molding machine, any kind of existing sensors for vibration detection are for instance possible, wherein preferably acceleration sensors, position sensors and the like can be used.

A measurement of the vibration by stimulation in a predetermined frequency range may be carried out several times—preferably 5 to 10 times—and the results of the measurement are used for diagnosis in a statistically evaluated calculated value (e.g. as a average value). Such a procedure of measuring several times and determining the results allows random scatterings to be taken into account, and its effect on the measuring result to be reduced. This repeated measurement can be carried out for instance within a test cycle, wherein a vibration is stimulated several times in succession by the at least one element.

Preferably, a frequency of the measured vibration for diagnosis is compared with a natural frequency of the at least one component to be diagnosed in a predefined state.

This natural frequency of the at least one component to be diagnosed in a predefined state can, for instance, be an optimum state of the component, which corresponds to an optimum in terms of material technology (for instance without cavity and material impurities) and/or shows no wear (for instance no hairline cracks have yet been formed) and/or is subject to an optimum operating condition (for instance is optimally preloaded).

If the frequency of the measured vibration deviates from the natural frequency of the at least one component to be diagnosed in a predefined state greater than/equal to a predetermined deviation, a damage and/or a defect and/or a misadjustment of the at least one component may be detected, wherein preferably an error message is output.

Regarding the deviation, a tolerance range can for instance be defined, so that a acceptable wear of the at least one component is taken into account.

The error message can for instance be limited to issuing an acoustic and/or visual warning signal to an operator. However, it can also be provided that, in response to the error message, a production is automatically stopped and/or the molding machine is automatically set into an stand-by mode.

The diagnosis can be carried out in a specially provided diagnostic cycle, which for instance can be started by an operator or is carried out automatically after a factory predefined number of operating hours, for instance to be able to determine the need for maintenance work.

Furthermore, the measuring results or already the results of the diagnosis can be transmitted via a data transmission link to the manufacturer of the molding machine or a maintenance service provider of the molding machine.

The data transmission link can preferably be designed as a remote data transmission link. The remote data transmission link can be implemented by means of a LAN (Local Area Network), WLAN (Wireless Local Area Network), WAN (Wide Area Network) and/or various (internet) protocols.

However, the data transmission and transfer to the manufacturer or a maintenance service provider can also be carried out manually via a storage medium (USB, hard disk drive) which is directly connected to the control unit of the molding machine.

Moreover, protection is requested for a molding machine with
at least one movable element, wherein a drive unit is designed to accelerate and/or decelerate the at least one movable element,
at least one measuring device for measuring a vibration of the molding machine, and
at least one control unit which is designed to carry out a method according to the invention according to one of the embodiments discussed.

A control unit can be understood as those components of the molding machine which allow actuators, drives and/or drive regulators to be controlled, which includes in particular so-called “programmable logic controllers” (PLC). This may include receiving sensor data and carrying out calculations for a control process, which may be performed in real time depending on the control schema.

The control unit of the molding machine can be realized by a central machine control of the molding machine or takes over its tasks.

The drive unit is preferably designed as a rotary drive, which transmits the rotary motion to the molding machine via at least one belt.

The drive unit can have at least one encoder, which is designed as a sensor of the measuring device for measuring a vibration.

Furthermore, a computer program product comprises commands which, when the program is executed by a computer, make the computer execute a method according to the invention.

### BRIEF DESCRIPTION OF THE DRAWINGS

Further exemplary advantages and details of the invention can be seen in the figures and the description below, in which:

FIG. 1 is a schematic illustration of an embodiment of a molding machine,

FIG. 2 shows a schematic sequence of an exemplary method according to the invention,

FIGS. 3a, 3b show exemplary profile dynamics of the speed profile of a closing unit to vibration stimulation, and

FIG. 4 shows an exemplary frequency analysis.

### DETAILED DESCRIPTION OF THE INVENTION

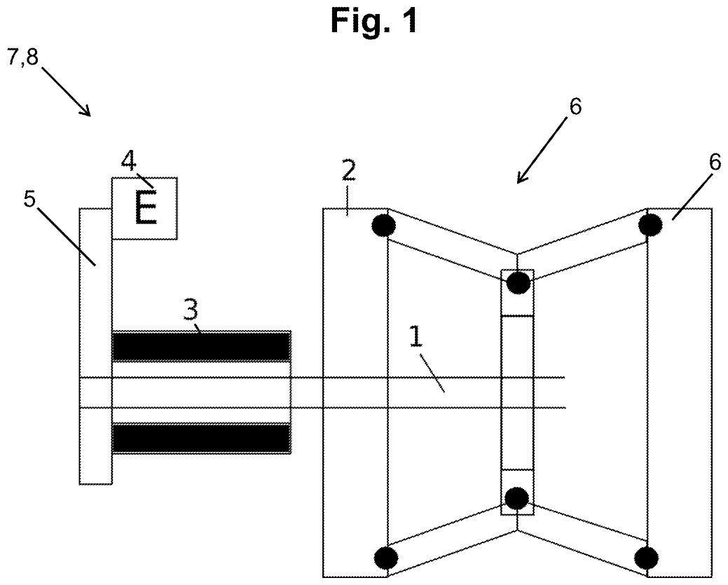

FIG. 1 shows a schematic illustration of an embodiment of a molding machine 7 according to the invention. More precisely, FIG. 1 shows a closing unit 8 of the molding machine 7, in which a movable plate 9 can be moved by means of a toggle mechanism 6 which is braced on a face plate 2. A plasticizing and injection unit known per se and possible peripheral devices are not shown.

In this embodiment, the toggle mechanism 6 is driven by a drive unit 3 via a hollow shaft 1, wherein the drive unit 3 in this particular embodiment is designed as a spindle drive.

The drive unit 3 is connected to an encoder 4 via a belt 5. This embodiment of a drive unit 3, which is connected to an encoder 4 via a belt 5, is known from the prior art, and is used to determine a position of the drive unit 3 and/or the closing unit 8 via the encoder 4.

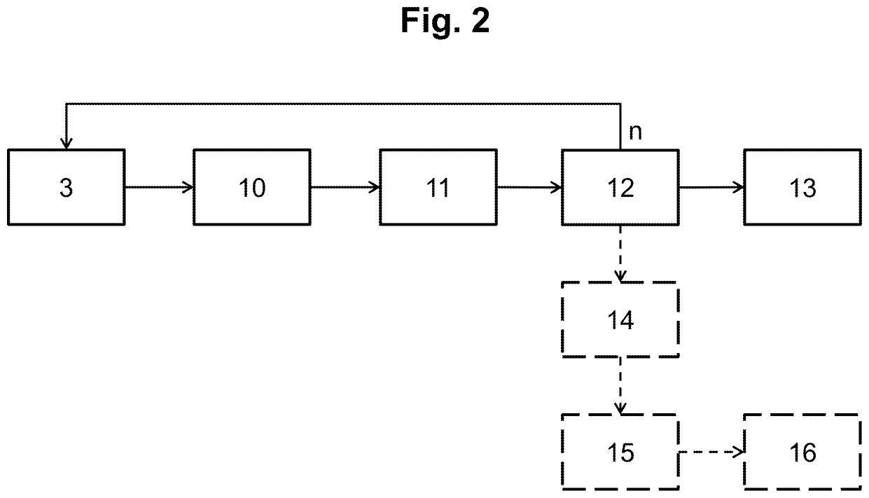

FIG. 2 shows a schematic sequence of an exemplary method according to the invention. To initiate the method for diagnosing a state of at least one component of the molding machine 7, a vibration 11 in a predetermined frequency range is first stimulated by accelerating or decelerating at least one movable element provided on the molding machine 7 (for instance of the movable plate 9) by appropriate control or regulation of the drive unit 3.

Depending on the desired frequency range of the vibration 11, the stimulation by the drive unit 3 can be changed.

Subsequently, a vibration 11 can be detected via a measuring device 10 of the molding machine 7 (for instance an encoder 4). This vibration 11 measured by the measuring device 10 can then be transmitted to a control unit 12 of the molding machine.

The stimulation to a vibration 11 in a predetermined frequency range and measurement by the measuring device 10 can be repeated n times by the control unit 12 (wherein n is greater than or equal to 1, preferably a repetition of 5 to 10 times is provided), in order to be able to take into account any unpredictable outliers that may be present by an averaged measuring result.

The control unit 12 of the molding machine can evaluate the results after the measurement procedure has been completed and output an error message 13 if the frequency of the vibration 11 deviates from a previously defined natural frequency of a component to be diagnosed by more than a tolerable deviation.

This error message 13 can make itself recognizable to an operator of the molding machine 7 as an acoustic and/or visual signal. However, it can also be provided alternatively or additionally that the molding machine 7 is automatically set to an idle state by the control unit 12.

In addition, as indicated by the dashed chain in FIG. 2, it may be provided that the signals of the measuring device 10 are transmitted by the control unit 12 to an external storage medium and/or calculation medium 15 by means of a data transmission link 14.

The calculation of a deviation of the frequency of the vibration 11 from a natural frequency of the component to be diagnosed may also be carried out in this external storage medium and/or calculation medium 15, wherein the deviation or the diagnosis result may be passed on to an external person or an external company 16.

The external person or the external company 16 may be, for instance, an owner or another person of the company who remotely monitors or controls the production of the molding machine 7. Access by a maintenance company or a molding machine manufacturer is also quite imaginable.

In an example of a closing and/or opening movement of a closing unit 8 by means of a movable plate 9 for stimulation of the vibration 11, the following characteristic quantities for changing the frequency range are obtained:
travelled lift,
speed,
clamping force, and
profile dynamics.

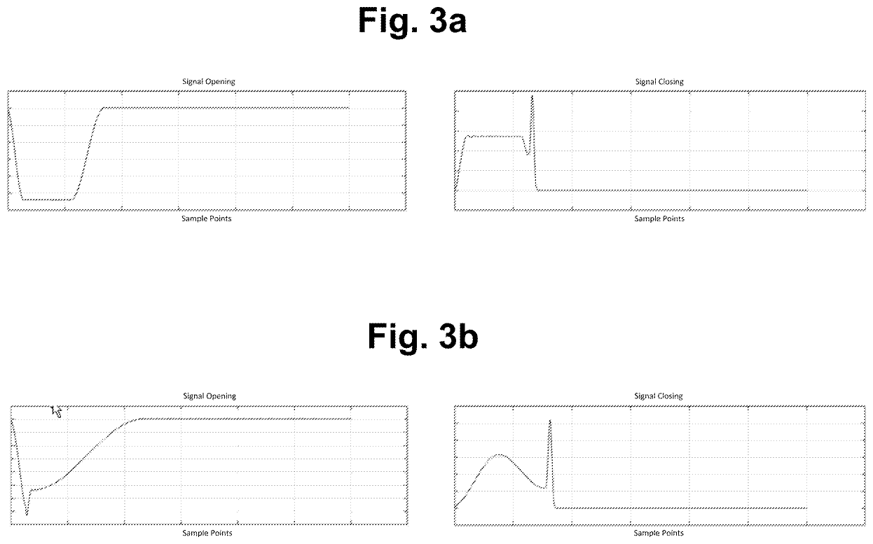

FIGS. 3a and 3b show how, by way of example, the profile dynamics of the speed profile of a closing unit 8 can be changed in order to stimulate a component to be diagnosed and/or the closing unit 8 and/or the entire molding machine 7 to a vibration 11 in a defined frequency range. The Y-axis represents the acceleration in arbitrary units.

In this context, FIG. 3a shows the profile dynamics of the speed profile of a closing unit 8, more precisely the speed profile of a movable plate 9 in the normal production cycle, wherein the opening movement is shown on the left side and the closing movement on the right side.

FIG. 3b shows an adapted profile dynamic for stimulation of a vibration 11, wherein again the opening movement is shown on the left and the closing movement on the right.

From comparing FIG. 3a directly with FIG. 3b, it can be seen how the profile dynamics setting creates a very good option for stimulating a vibration 11 in a certain frequency range, even with little freedom of movement available (such as, for instance, the lift of the movable plate 9).

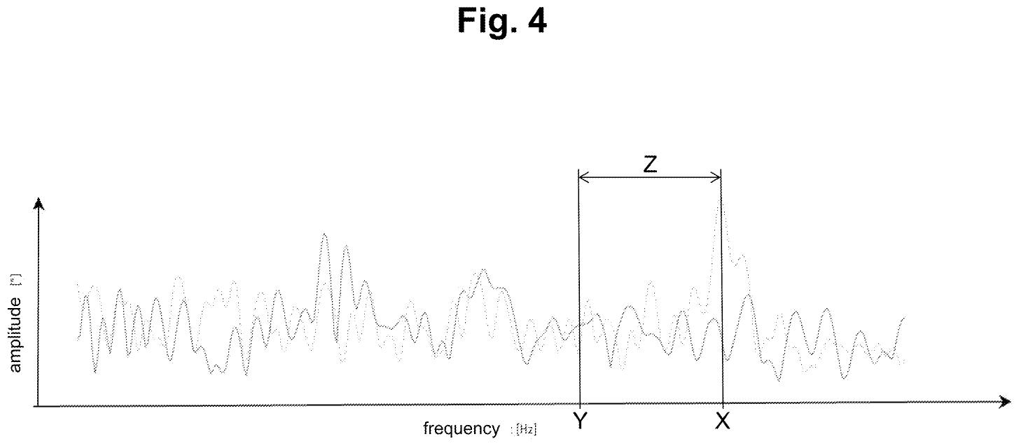

FIG. 4 now shows an exemplary frequency analysis, wherein a molding machine 7 has been stimulated to a vibration, which is shown as a solid line.

Then, a measurement was made by a measuring device 10 on the molding machine 7, wherein the measured vibration 11 is shown by the dashed line.

It can be seen that a deflection of the amplitude of the measured vibration 11 forms in a frequency range of X, which provides direct information about the state of the at least one component to be diagnosed.

Since a natural frequency of the at least one component to be diagnosed of Y has now been defined in the optimum case, a frequency deviation of the vibration of approx. Z can be determined, wherein it has been found from testing that a defect of the at least one component to be diagnosed is to be assumed already from a deviation smaller than Z.

Consequently, in this case, an error message 13 can be output by the control unit 12.

### LIST OF REFERENCE SIGNS

1 hollow shaft
2 face plate
3 drive unit
4 encoder
5 belt
6 toggle mechanism
7 molding machine
8 closing unit
9 movable plate
10 measuring device
11 vibration
12 control unit
13 error message
14 data transmission link
15 external storage medium and/or calculation medium
16 external person or external company

1. A method for diagnosing a state of at least one component of a molding machine, wherein a state of the at least one component is determined on the basis of a vibration measured at the molding machine, wherein a drive unit of the molding machine accelerates and/or decelerates at least one movable element provided at the molding machine in such a way that the vibration is stimulated in a predetermined frequency range.

2. The method according to claim 1, wherein the predetermined frequency range is selected such that at least one natural frequency of the at least one component to be diagnosed lies in the predetermined frequency range.

3. The method according to claim 1, wherein the predetermined frequency range is defined by a plus/minus of 5% of the natural frequency around the natural frequency of the at least one component to be diagnosed.

4. The method according to claim 1, wherein as vibration, a vibration of the molding machine and/or of the at least one movable element and/or of the at least one component to be diagnosed is stimulated.

5. The method according to claim 1, wherein at least one ambient condition is taken into account when defining the predetermined frequency range.

6. The method according to claim 1, wherein a movable plate of a molding machine is used as the movable element, which is accelerated and/or decelerated via a closing unit, which preferably has a toggle mechanism.

7. The method according to claim 1, wherein a measuring device of the molding machine is used to measure the vibration.

8. The method according to claim 1, wherein a measurement of the vibration by stimulation in a predetermined frequency range is carried out several times—preferably 5 to 10 times—and the results of the measurements are used as an average value for diagnosis.

9. The method according to claim 1, wherein a frequency of the measured vibration is compared for diagnosis with a natural frequency of the at least one component to be diagnosed in a predefined state.

10. The method according to claim 9, wherein, in the event of a deviation of the frequency of the measured vibration with respect to the natural frequency of the at least one component to be diagnosed in the predefined state, being greater than/equal to a predetermined deviation, a damage and/or a defect and/or a misadjustment of the at least one component is detected, wherein preferably an error message is output.

11. A molding machine with
at least one movable element, wherein a drive unit is designed in order to accelerate and/or decelerate the at least one movable element,
at least one measuring device for measuring a vibration of the molding machine, and
at least one control unit configured to carry out the method according to claim 1.

12. The molding machine according to claim 11, wherein the drive unit is designed as a rotational drive which transmits the rotational movement to the molding machine via at least one belt.

13. The molding machine according to claim 11, wherein the drive unit comprises at least one encoder which is designed as a sensor of the measuring device for measuring a vibration.

14. A computer program product comprising commands which, when the program is executed by a computer, instruct the computer to execute the method of claim 1.
